(19) United States
(12) Patent Application Publication
(10) Pub. No.: US 2025/0208817 A1
(43) Pub. Date: Jun. 26, 2025

(54) Deformable Electronic Device and Methods for Configuring and Operating the Same

(71) Applicant: Motorola Mobility LLC, Chicago, IL (US)

(72) Inventors: Keith J Pump, Chicago, IL (US); Giles T Davis, Downers Grove, IL (US); Thomas Gitzinger, Libertyville, IL (US)

(21) Appl. No.: 18/395,545

(22) Filed: Dec. 23, 2023

(51) Int. Cl. G06F 3/14; G06F 3/01; G09G 3/00

(52) U.S. Cl. CPC G06F 3/1446; G06F 3/013; G09G 3/035; G09G 2300/026; G09G 2354/00

(57) ABSTRACT

A deformable electronic device includes a first section carrying a first display and a second section that is both bendably coupled to the first section and devoid of any display. The deformable electronic device also includes a third section that carries a second display and is bendably coupled to the second section. The first display and the second display are oppositely facing. The deformable electronic device can be bent such that the first display and second display are aligned along a minor edge, aligned along a major edge, are oppositely facing, are configured as a tent, a stand, or even a loop. The number of sections carrying displays and devoid of displays can be increased to increase the total number of sections of the deformable electronic device.

### BACKGROUND

### Technical Field

This disclosure relates generally to electronic devices and corresponding methods, and more particularly to physically deformable electronic devices.

### Background Art

Portable electronic communication devices, especially smartphones, have become ubiquitous. People all over the world use such devices to stay connected. These devices have been designed in various mechanical configurations. A first configuration, known as a “candy bar,” is generally rectangular in shape, has a rigid form factor, and has a display disposed along a major face of the electronic device. By contrast, a “clamshell” device has a mechanical hinge that allows one housing to pivot relative to the other. A third type of electronic device is a “slider” where one device housing slides relative to the other.

Some consumers prefer candy bar devices, while others prefer clamshell devices. Still others prefer sliders. It would be advantageous to have electronic devices with additional form factors to provide users with additional configuration options.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates a first side of one explanatory electronic device configured in accordance with one or more embodiments of the disclosure.

FIG. 2 illustrates a second side of one explanatory electronic device configured in accordance with one or more embodiments of the disclosure.

FIG. 3 illustrates one or more explanatory method steps for configuring one explanatory electronic device configured in accordance with one or more embodiments of the disclosure.

FIG. 4 illustrates one or more other explanatory method steps for configuring one explanatory electronic device configured in accordance with one or more embodiments of the disclosure.

FIG. 5 illustrates still other explanatory method steps for configuring one explanatory electronic device configured in accordance with one or more embodiments of the disclosure.

FIG. 6 illustrates still more explanatory method steps for configuring one explanatory electronic device configured in accordance with one or more embodiments of the disclosure.

FIG. 7 illustrates even more explanatory method steps for configuring one explanatory electronic device configured in accordance with one or more embodiments of the disclosure.

FIG. 8 illustrates one explanatory electronic device in accordance with one or more embodiments of the disclosure.

FIG. 9 illustrates a sectional view of one or more folding components of an electronic device configured in accordance with one or more embodiments of the disclosure.

FIG. 10 illustrates another explanatory electronic device in accordance with one or more embodiments of the disclosure.

FIG. 11 illustrates yet another explanatory electronic device in accordance with one or more embodiments of the disclosure.

FIG. 12 illustrates still another explanatory electronic device in accordance with one or more embodiments of the disclosure.

FIG. 13 illustrates yet another explanatory electronic device in accordance with one or more embodiments of the disclosure.

FIG. 14 illustrates one explanatory method in accordance with one or more embodiments of the disclosure.

FIG. 15 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to a deformable electronic device having at least two sections carrying displays and at least one section that is devoid of a display, wherein the at least two displays are oppositely facing. Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

It will be appreciated that embodiments of the disclosure described herein may be comprised of one or more conventional processors and unique stored program instructions that control the one or more processors to implement, in conjunction with certain non-processor circuits, some, most, or all of the functions of presenting content on displays of an electronic device and performing other operations as described herein. The non-processor circuits may include, but are not limited to, a radio receiver, a radio transmitter, signal drivers, clock circuits, power source circuits, and user input devices. As such, these functions may be interpreted as steps of a method to perform these operations. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide a deformable electronic device having at least two displays that are separated from each other by a section that is devoid of a display, thereby allowing the at least two displays to be deformed and configured in multiple ways. Illustrating by example, in one or more embodiments the deformable electronic device comprises a first section comprising a first display, a second section that is bendably coupled to the first section and that is also devoid of a display, and a third section that is bendably coupled to the second section and that comprises a second display. In one or more embodiments, the first display and the second display are oppositely facing.

In one or more embodiments, the three sections can be deformed in different directions so that each of the first section and the third section can abut different sides of the second section. Illustrating by example, when the first section extends distally from the second section and the third section abuts the second section such that the first display and the second display face the same direction, this “alignment on the short edge” configuration creates a long display that can be suitable for cinematic aspect ratios or for wearable applications.

By contrast, when the third section extends distally from the second section and the first section abuts the second section with the first display and the second display facing in the same direction, this “alignment on the long edge” configuration creates a more rectangular display, which is suitable for smartphone or tablet computer user interaction. In other embodiments, this “alignment on the long edge” configuration can be folded in half to conceal both the first display and the second display for protection of the displays or pocket carry.

When both the first section and the third section abut the second section such that the first display and the second display face in opposite directions, this “back-to-back” configuration creates a very compact design suitable for carrying in a pocket, multi-user interactions, or even for taking selfies.

When the third section extends distally from the second section and the first section abuts the third section such that the displays face in the same direction, in one or more embodiments, the third section can be partially bent relative to the second section such that the deformable electronic device resembles a tent. This “tent” configuration is suitable for positioning the deformable electronic device on a surface or for multi-user interactions. Similarly, when the first section extends distally from the second section and the third section abuts the second section such that the displays face in the same direction, in one or more embodiments, the first section can be partially bent relative to the second section such that the deformable electronic device. This “stand” configuration works well when a user desires to place the deformable electronic device on a surface during use.

In one or more embodiments, each of the first section, the second section, and the third section are the same size. Said differently, an area of a major surface of the first section is the same as the area occupied by a major surface of both the second section and third section, and vice versa. In one or more embodiments, the aspect ratio defining this area is 21:9. In another embodiment, the aspect ratio defining this area is 8:9. Still other aspect ratios suitable for configuring the section sizes will be obvious to those of ordinary skill in the art having the benefit of this disclosure.

In one or more embodiments, the sections are hingedly coupled to each other. In other embodiments, a deformable device housing spans the three sections and allows each section to be deformed relative to others to which it is connected.

In some embodiments the displays are rigid. However, in other embodiments, such as those suitable for wearable applications, the displays are flexible.

One or more processors can be operable to present content on the displays. In one or more embodiments, the one or more processors and other electronics are situated in the section or sections of the deformable electronic device that are devoid of displays. In one or more embodiments, the one or more processors are operable to detect a geometric configuration of the deformable electronic device where the first display and the second display are adjacent. When this occurs, such as when the deformable electronic device is in the tent or stand configurations, the one or more processors can segment content for presentation into a first content portion and a second content portion. Thereafter, the one or more processors can cause the first display to present the first content portion and the second display to present the second content portion.

In one or more embodiments, a method in a deformable electronic device comprises detecting, using one or more sensors, deformation of the deformable electronic device. In one or more embodiments, the one or more sensors determine whether the deformation results in a first display and a second display being adjacent or oppositely facing.

In one or more embodiments, when the first display and the second display are adjacent, one or more processors segment presentation content into a first content portion and a second content portion and cause the first display to present the first content portion and the second display to present the second content portion. By contrast, when the first display and the second display are oppositely facing, the one or more processors either cause the first display to present the presentation content and the second display to cease presentation of any content or cause the first display to present the presentation content and the second display to present other presentation content.

In one or more embodiments, a deformable electronic device comprises a plurality of sections each comprising a corresponding display. However, in one or more embodiments at least one section of the deformable electronic device is devoid of a display. In one or more embodiments, at least two sections of the plurality of sections are bendable relative to the at least one section. In one or more embodiments, displays of at least two sections are oppositely facing.

In many embodiments, the plurality of sections will comprise only two sections as this allows for a compact form factor that when maximally folded is easy to carry in a pocket. However, embodiments of the disclosure are not so limited in that the number of sections including displays, as well as those devoid of displays, can be expanded as well.

Illustrating by example, in another embodiment, the plurality of sections carrying displays comprises four sections, while the number of sections devoid of displays comprises three sections. In still another embodiment, the plurality of sections carrying displays comprises six sections, while the number of sections devoid of displays comprises five sections. In many embodiments, the number of sections carrying displays will be one section greater than the number of sections that are devoid of displays.

More generally, in one or more embodiments the number of sections that are devoid of displays will be equal to the following formula:

$$2 * ( X - 1 ) \qquad [ EQ . 1 ]$$

where X is the number of sections carrying displays. In one or more embodiments, these deformable electronic devices define a stair-stepped perimeter when in a non-deformed configuration.

Advantageously, embodiments of the disclosure allow displays to abut on a long side, abut on a short side, face in opposite directions, and be configured in tent, stand, and other configurations to provide a user with many different options for consuming content. In deforming the electronic device, large, wide displays can be defined, large, narrow displays can be defined, oppositely facing displays can be configured, and even wrist-wearable configurations can be established. Other advantages will be described below. Still others will be obvious to those of ordinary skill in the art having the benefit of this disclosure.

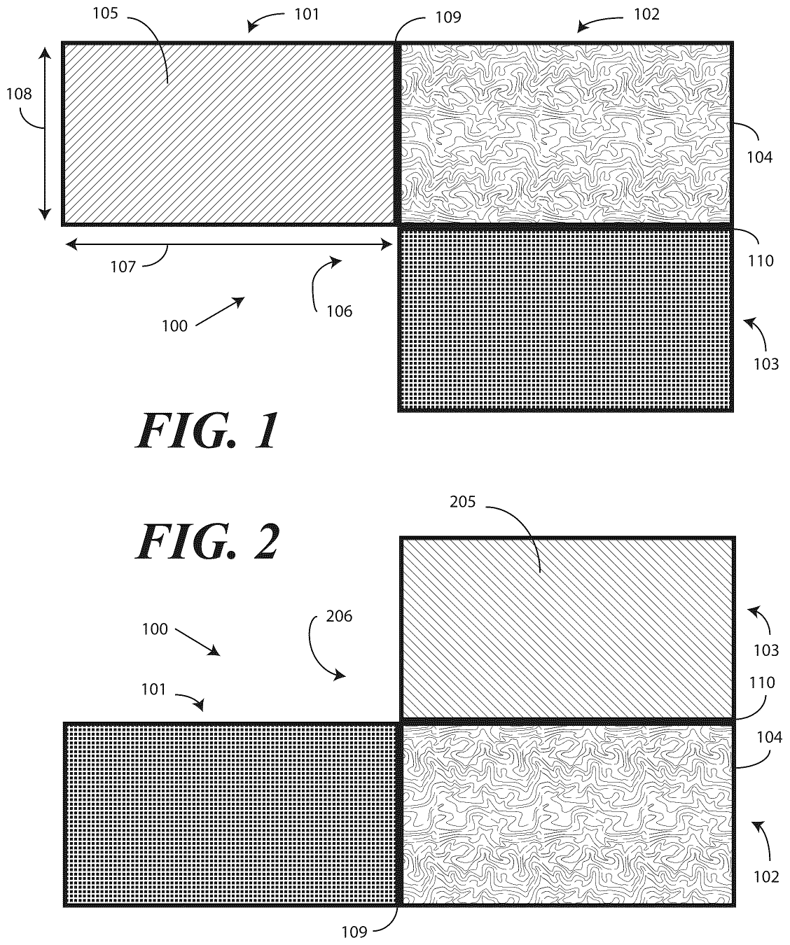

Turning now to FIGS. 1-2, illustrated therein is one explanatory electronic device 100 configured in accordance with one or more embodiments of the disclosure. The electronic device 100 of FIG. 1 is a portable electronic device, and can be configured to operate as a smartphone, tablet computer, gaming device, or other type of device. FIG. 1 illustrates a first side 106 of the electronic device 100, while FIG. 2 illustrates a second side 206, which is oppositely facing from the first side 106.

The explanatory electronic device 100 of FIG. 1 has a device housing 104 that is divided into three sections, namely, a first section 101, a second section 102, and a third section 103. In this illustrative embodiment, the first section 101 comprises a first display 105. The second section 102, which is bendably coupled to the first section 101, is devoid of any display. The third section 103, which is bendably coupled to the second section 102, comprises a second display 205.

In this illustrative embodiment, the first display 105 and the second display 205 are situated on opposite sides of the electronic device 100. To wit, the first display 105 is situated on the first side 106 of both the first section 101 and the electronic device 100 itself, while the second display 205 is situated on the second side 206 of both the third section 103 and the electronic device 100. Accordingly, in this illustrative embodiment the first display 105 and the second display 205 are oppositely facing.

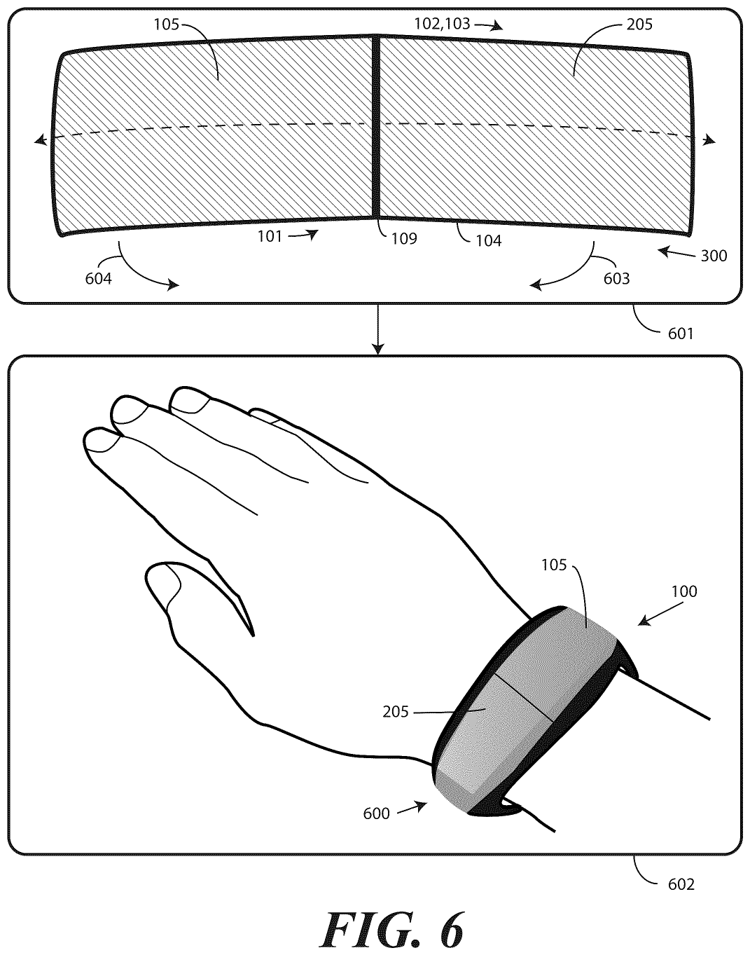

In one or more embodiments, one or both of the first display 105 and/or the second display 205 is touch sensitive. One or both of the first display 105 and/or the second display 205 can serve as a primary user interface of the electronic device 100. Users can deliver user input to the first display 105 and/or the second display 205 of such an embodiment by delivering touch input from a finger, stylus, or other objects disposed proximately with the display. In one embodiment, the first display 105 and/or the second display 205 are configured as an organic light emitting diode (OLED) displays. In some embodiments the first display 105 and/or the second display 205 are rigid displays. However, in other embodiments, one example of which will be illustrated and described below with reference to FIG. 6, the first display 105 and/or the second display 205 are configured as an OLED display fabricated on a flexible plastic substrate. In still other embodiments, the first display 105 is rigid while the second display 205 is flexible, and vice versa.

When the first display 105 and/or the second display 205 is constructed on flexible plastic substrates, this can allow the first display 105 and/or the second display 205 to become flexible in one or more embodiments with various bending radii. For example, some embodiments allow bending radii of between thirty and six hundred millimeters to provide a bendable display. Other substrates allow bending radii of around five millimeters to provide a display that is foldable through active bending. Other displays can be configured to accommodate both bends and folds. In one or more embodiments the first display 105 and/or the second display 205 may be formed from multiple layers of flexible material such as flexible sheets of polymer or other materials.

In the illustrative embodiment of FIGS. 1-2, the device housing 104 supports both the first display 105 and the second display 205. In one or more embodiments, the device housing 104 is flexible. In one embodiment, the device housing 104 may be manufactured from a malleable, bendable, or physically deformable material such as a flexible thermoplastic, flexible composite material, flexible fiber material, flexible metal, organic or inorganic textile or polymer material, or other materials.

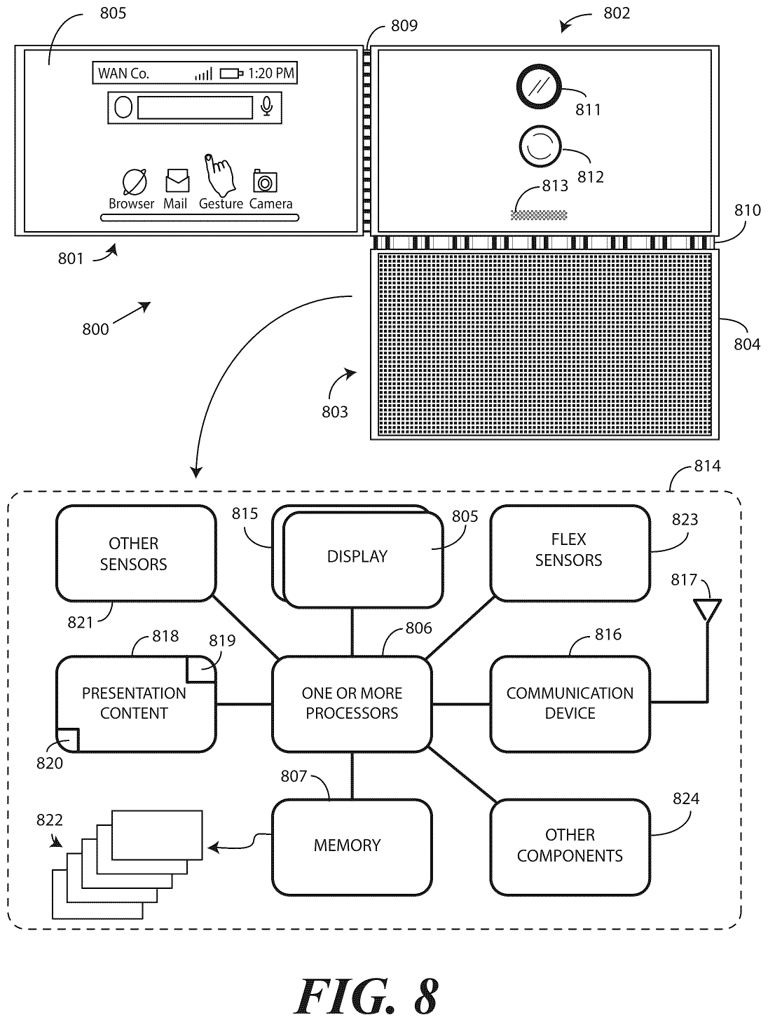

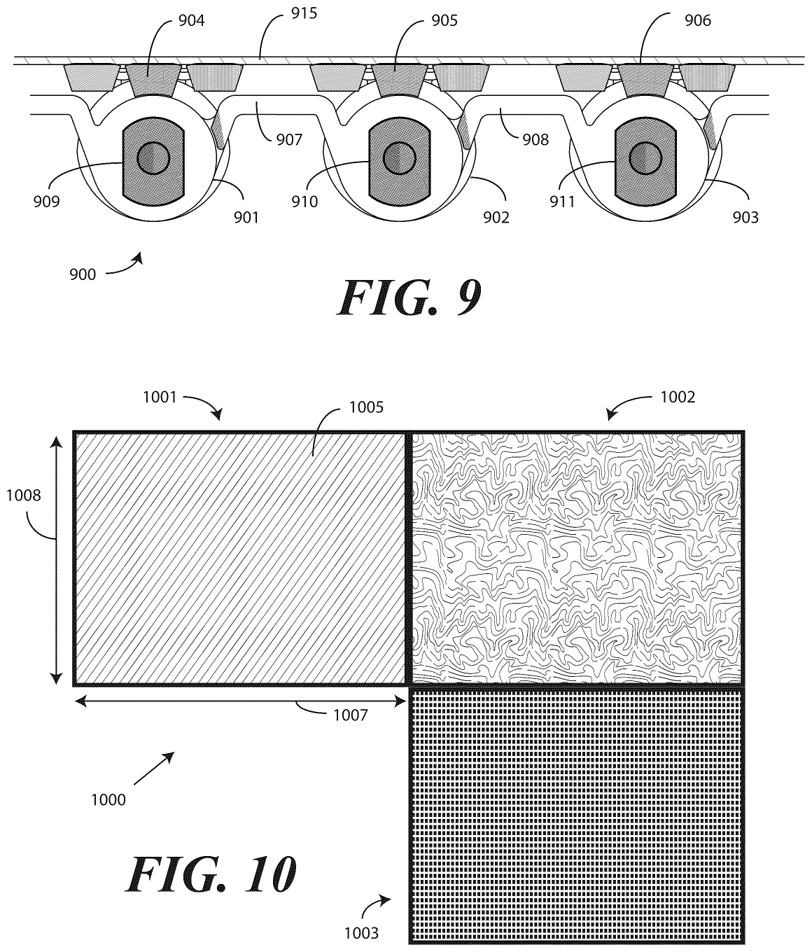

In other embodiments, one example of which will be described below with reference to FIG. 9, the device housing 104 could also be a combination of rigid segments connected by hinges, pivots, or flexible materials. Illustrating by example, the device housing 104 can include one or more linkage members that allow the electronic device 100 to be deformed by bending or folding. Still other constructs will be obvious to those of ordinary skill in the art having the benefit of this disclosure.

Where the device housing 104 is a deformable housing, it can be manufactured from a single flexible housing member or from multiple flexible housing members. As will be explained below with reference to FIG. 8, user interface components, which may be a button or touch sensitive surface, can also be disposed along the device housing 104 to facilitate control of the electronic device 100. Other features can be added as well. In many embodiments, these user interface components and other features will be situated along the second section 102 that is devoid of any display.

Alternatively, in other embodiments they can be situated on the first section 101 or third section 103 on a side not supporting a display, i.e., the second side 206 of the first section 101 or the first side 106 of the third section 103. Illustrating by example, in one or more embodiments a first image capture device can be disposed on the second side 206 of the first section 101, while a second image capture device is disposed on the first side 106 of the third section 103. Alternatively, oppositely facing image capture devices can be situated on the first side 106 and second side 206 of the second section 102. Other configurations will be obvious to those of ordinary skill in the art having the benefit of this disclosure.

In this illustrative embodiment, the device housing 104 is singular, and therefore spans the first section 101, the second section 102, and the third section 103. In one or more embodiments, this singular device housing 104 defines a first deformable portion 109 between the first section 101 and the second section 102, and also defines a second deformable portion 110 between the second section 102 and the third section 103. This results in the first section 101 and the third section 103 being hingedly coupled to the second section 102.

In this illustrative embodiment, each section of the first section 101, the second section 102, and the third section 103 are the same size. Said differently, in one or more embodiments the first section 101, the second section 102, and the third section 103 have the same length 107 and width 108. In this illustrative embodiment, the length 107 is greater than the width 108. However, in other embodiments the length 107 and width 108 will be the same. The length 107 runs parallel to a major axis of the sections, while the width 108 runs parallel to a minor axis of the sections.

In one or more embodiments, the length 107 and width 108 define an aspect ratio for the first display 105 and the second display 205. Since the length 107 and width 108 of each of the first section 101, the second section 102, and the third section 103 is the same in this illustrative embodiment, the aspect ratio of the first display 105 and the second display 205 are the same.

In one or more embodiments, the aspect ratio of the first display 105 and the second display 205 is 21:9. In other embodiments, the aspect ratio of the first display 105 and the second display 205 is 8:9. These aspect ratios are illustrative only, as others will be readily obvious to those of ordinary skill in the art having the benefit of this disclosure. The aspect ratio of the first display 105 and the second display 205 in FIG. 1 is 21:9.

The fact that the first section 101 is hingedly coupled to the second section 102, with the third section 103 also being hingedly coupled to the second section 102, allows the electronic device 100 of FIG. 1 to be configured as a many different devices. Advantageously, this allows the electronic device 100 to function as the equivalent to multiple devices depending upon the amount of deformation of the device housing 104.

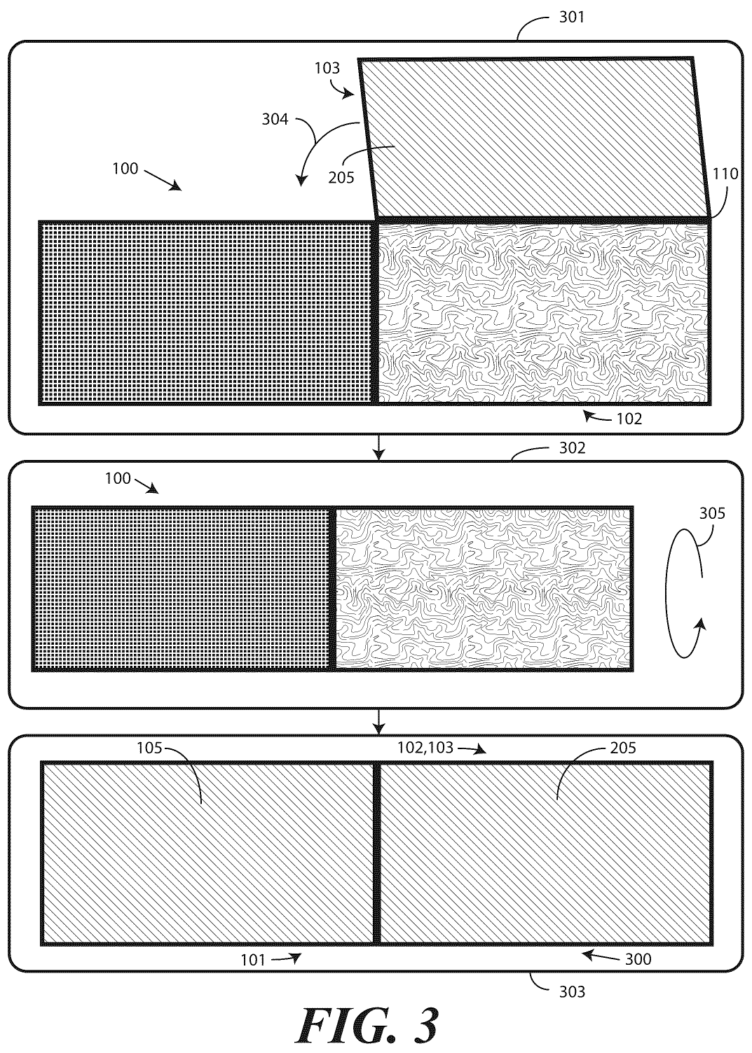

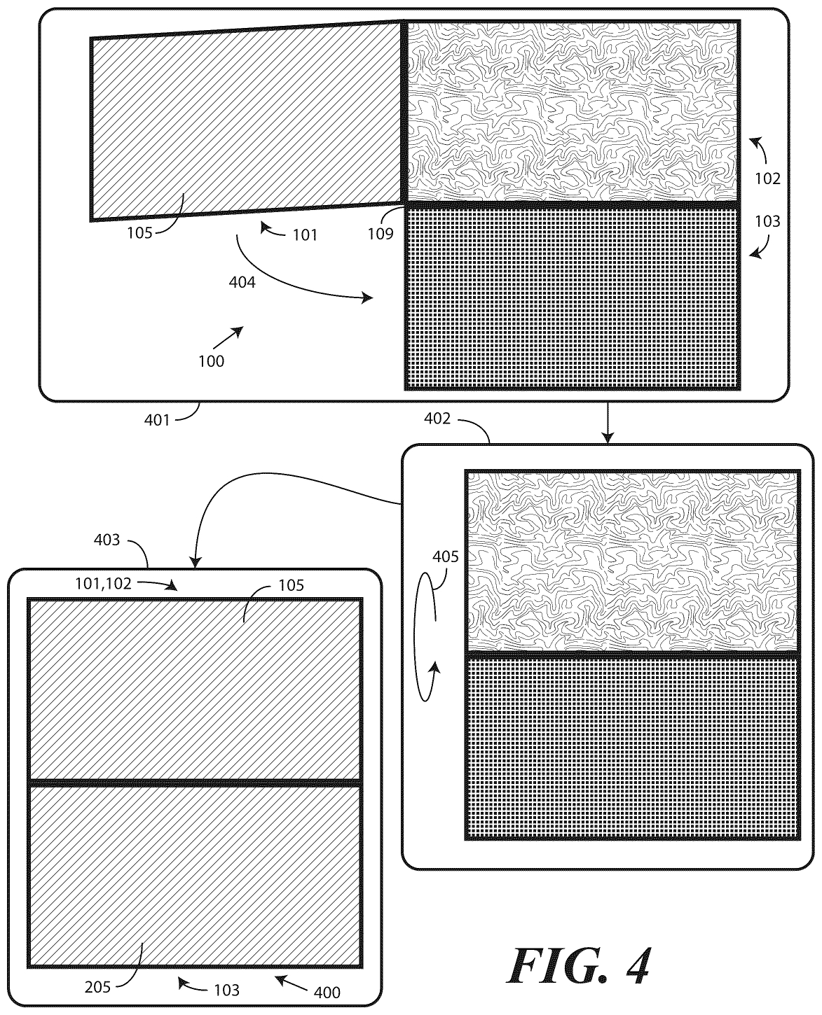

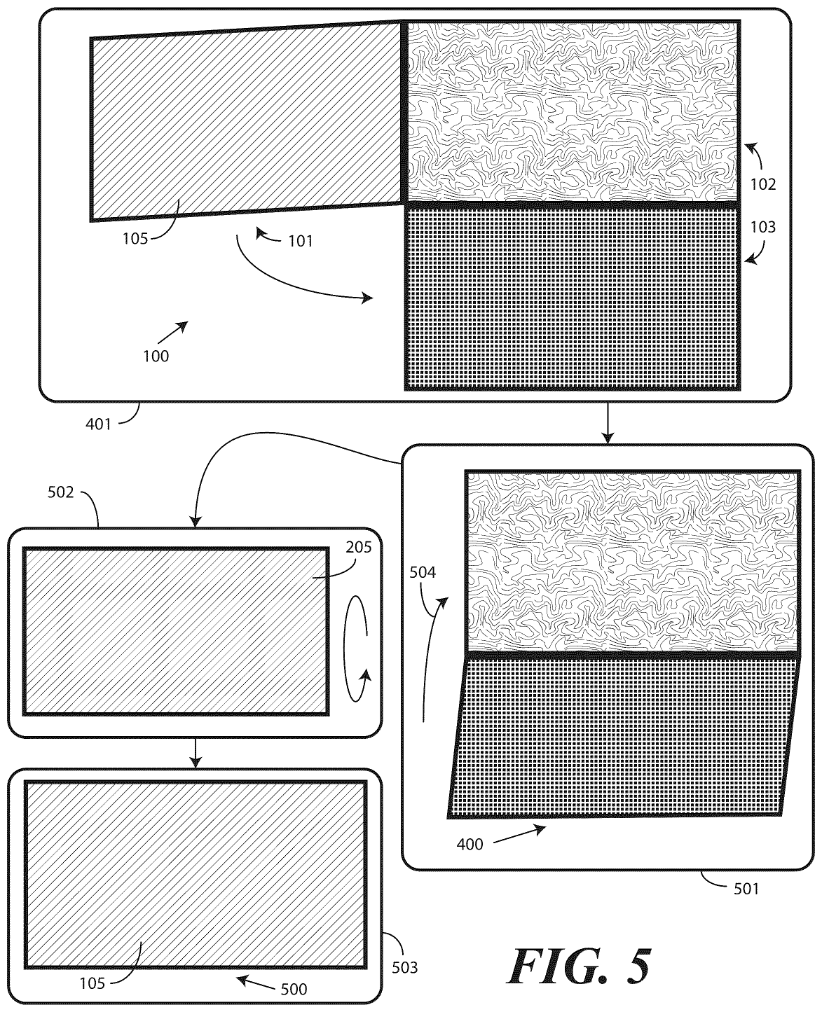

For example, the electronic device 100 is shown in an unbent configuration in FIG. 1. However, when folded as described in FIG. 3, the electronic device 100 can function as a smartphone. By contrast, when folded as described in FIG. 4, the electronic device 100 can function as a tablet computer. Where folded as described in FIG. 5, two people situated on opposite sides of the electronic device 100 can each view a corresponding display. Where the first display 105 and the second display 205 are flexible, and when the electronic device is folded as described below with reference to FIG. 6, the electronic device 100 can be configured in a loop so as to be worn on a wrist. Moreover, when folded as described below with reference to FIG. 4, and then partially folded between the first display 105 and the second display 205, the electronic device 100 can be configured as a tent and can accordingly function as a table clock, content viewer, or auxiliary display when in a bent condition. It should be obvious to those of ordinary skill in the art having the benefit of this disclosure that the electronic device 100 can function as other devices as a function of its physical geometry, including as a gaming device, a media player, or other device.

Turning now to FIG. 3, illustrated therein are one or more method steps illustrating how the electronic device 100 of FIG. 1 can be deformed into a first configuration where the first display 105 and the second display 205 are adjacent along their minor edges. This is sometimes referred to as an “alignment on the short edge” configuration 300.

Beginning at step 301, the electronic device 100 as shown in FIG. 2 is deformed. Specifically, the third section 103 carrying the second display 205 is bent 304 at the second deformable portion 110 relative to the second section 102. In this illustrative embodiment, the bending 304 continues until the first side (106) of the third section 103 abuts the first side (106) of the second section 102. This result is shown at step 302. At step 302, the electronic device 100 is then turned over 305.

As shown at step 303, this results in the minor edge of the first display 105 being adjacent to the minor edge of the second display 205. Where the aspect ratio of the first display 105 and the second display 205 are each 12:8, this results in a display with a 24:8 aspect ratio.

Thus, when the first section 101 extends distally from the second section 102 and the third section 103 abuts the second section 102 such that the first display 105 and the second display 205 face the same direction (out from the page at step 302), this “alignment on the short edge” configuration 300 creates a long display that can be suitable for cinematic aspect ratios or for wearable applications.

Illustrating by example, turning briefly to FIG. 6, at step 601 this “alignment on the short edge” configuration 300 is shown. At step 601, the device housing 104 is not only deformable at the first deformable portion 109 and the second deformable portion (110) but is also deformable along a major axis of each of the first section 101, the second section 102, and the third section 103.

At step 601, the third section 103 is bent relative to the second section 102 such that the third section 103 and second section 102 abut, as previously described. At step 601, the combined second section 102 and third section 103 are further bent 603 along the major axis toward the first section 101 while the first section is bent 604 along the major axis toward the combined second section 102 and the third section 103 until both minor edges of the first display 105 and the second display 205 abut. This results in the exterior surface defined by the first display 105 and the second display 205 defining a “loop” configuration 600, as shown at step 602. This allows the electronic device 100 to be worn around a wrist or positioned around another object.

Turning now to FIG. 4, illustrated therein are one or more other method steps illustrating another way the electronic device 100 of FIG. 1 can be deformed into a second configuration where the first display 105 and the second display 205 are adjacent along their major edges. This is sometimes referred to as an “alignment on the long edge” configuration 400.

Beginning at step 401, the electronic device 100 as shown in FIG. 1 is deformed. Specifically, the first section 101 carrying the first display 105 is bent 404 at the first deformable portion 109 relative to the second section 102. In this illustrative embodiment, the bending 404 continues until the second side (206) of the first section 101 abuts the second side (206) of the second section 102. This result is shown at step 402. At step 402, the electronic device 100 is then turned over 405.

As shown at step 403, this results in the major edge of the first display 105 being adjacent to the major edge of the second display 205. Where the aspect ratio of the first display 105 and the second display 205 are each 8:9, this results in a display with a 16:9 aspect ratio.

Thus, when the third section 103 extends distally from the second section 102 and the first section 101 abuts the second section 102 with the first display 105 and the second display 205 facing in the same direction (out of the page at step 403), this “alignment on the long edge” configuration 400 creates a more rectangular display. In one or more embodiments, this configuration is suitable for smartphone or tablet computer user interaction.

Turning now to FIG. 5, step 401 can be repeated. However, at step 501, the “alignment on the long edge” configuration 400 can be folded 504 in half with the first side (106) of the second section 102 moving toward the first side (106) of the third section 103. As shown at steps 503-504, this results in the first display 105 and second display 205 being outwardly facing.

Thus, when both the first section 101 and the third section 103 abut the second section 102 such that the first display 105 and the second display 205 face in opposite directions, this “back-to-back” configuration 500 creates a very compact design suitable for carrying in a pocket, multi-user interactions, or even for taking selfies. In other embodiments, the configuration of step 402 can be folded the other way to conceal both the first display 105 and the second display 205 for protection of the displays or pocket carry.

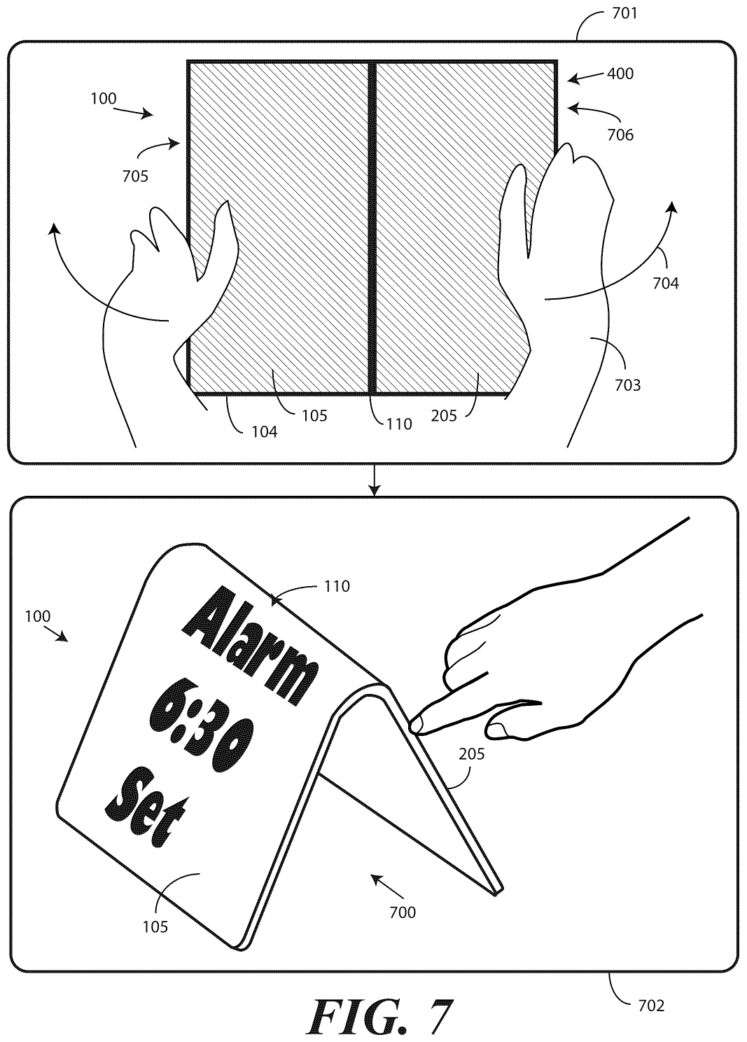

While the electronic device 100 is fully bent into the “back-to-back” configuration 500 in FIG. 5, in other embodiments it can be partially folded to create a tent configuration. Turning now to FIG. 7, illustrated therein is how this can occur.

At step 701, the electronic device 100 is in the this “alignment on the long edge” configuration 400. A user 703 is executing a bending operation 704 upon the electronic device 100 to impart deformation at the second deformable portion 110 of the electronic device 100.

In this illustration, the user 703 is applying force (into the page) at the first side 705 and a second side 706 of the electronic device 100 to bend both device housing 104. Internal components can be disposed on flexible substrates that bend as well at the second deformable portion 110 in one or more embodiments. This method of deforming the device housing 104 allows the user 703 to simply and quickly bend the electronic device 100 into a desired deformed physical configuration or shape.

It should be noted that while bending operations 704 will be used in many embodiments, embodiments of the disclosure are not so limited. In other embodiments, rather than relying upon the manual application of force, the electronic device 100 can include a mechanical actuator operable with one or more processors to deform the device housing 104 by one or more bends.

For example, a motor or other mechanical actuator can be operable with structural components to bend the electronic device 100 to predetermined angles and physical configurations in one or more embodiments. The use of a mechanical actuator allows a precise bend angle or predefined deformed physical configurations to be repeatedly achieved without the user 703 having to make adjustments. However, in other embodiments the mechanical actuator will be omitted to reduce component cost.

Regardless of whether the bending operation 704 is a manual one or is instead one performed by a mechanical actuator, in one or more embodiments it results in the device housing 104 being deformed by one or more bends. One result 700 of the bending operation 704 is shown at step 702. In this illustrative embodiment, the electronic device 100 is deformed by a single, partial bend at the second deformation portion 110. However, as described above, for example with reference to FIG. 6, in other embodiments the one or more bends can comprise a plurality of bends. Other deformed configurations will be obvious to those of ordinary skill in the art having the benefit of this disclosure.

At step 702, the result 700 is that the electronic device 100 is configured in the physical configuration that resembles a card folded into a “tent fold.” In this configuration, the electronic device 100 can stand on its side or ends on a flat surface such as a table. This configuration can make the first display 105 and second display 205 easier for the user 703 to view since they do not have to hold the electronic device 100 in their hands.

In one embodiment, one or more processors of the electronic device 100 are operable to detect that a bending operation 704. Illustrating by example, this can be done by detecting a change in an impedance of one or more flex sensors. The one or more processors, which may be situated in the second section (102) can detect this bending operation 704 in other ways as well.

For example, touch sensors operable with the first display 105 and the second display 205 can detect touch and pressure from the user 703. Alternatively, proximity sensors can detect the first side 705 and the second side 706, for example, of the electronic device 100 getting closer together. Force sensors can detect an amount of force that the user 703 is applying to the device housing (104) as well. In still other embodiments, the user 703 can input information indicating that the electronic device 100 has been bent using the first display 105, the second display 205, or another user interface. Other techniques for detecting that the bending operation 704 has occurred will be obvious to those of ordinary skill in the art having the benefit of this disclosure.

Several advantages offered by the “bendability” of embodiments of the disclosure are illustrated in FIG. 7. For instance, in one or more embodiments the one or more processors of the electronic device 100 are operable to, when the device housing (104) is deformed by one or more bends, present content, information, and/or user actuation targets on the first display 105, which is situated to a first side of a bend, while receiving user input in the form of touch at the second display 205, which is situated to a second side of the bend. This allows a user to see content on the first display 105 and control the content by delivering touch input to the second display 205. In one or more embodiments, the one or more processors are operable to detect the number of folds in the electronic device 100 resulting from the bending operation 704. In one embodiment, after determining the number of folds, the one or more processors can partition content to be presented into a first portion and a second portion, and then cause the first display 105 to present the first portion while the second display 205 presents the second portion. Since there is a single bend in FIG. 7, content has been partitioned into a first portion and a second portion, with each portion being presented on opposite sides of the “tent.”

Turning now to FIG. 8, illustrated therein is another electronic device 800 configured in accordance with one or more embodiments of the disclosure. In one or more embodiments, the electronic device 800 includes a device housing 804 that includes one or more linkage members situated at a first deformable portion 809 and a second deformable portion 810. These linkage members allow the electronic device 800 to be deformed by bending or folding. Advantageously, this allows the electronic device 800 to function as the equivalent to multiple devices depending upon the amount of deformation of the device housing 804.

For example, the electronic device 800 is shown in an unbent configuration in FIG. 8. However, as noted above with reference to FIG. 7, electronic devices configured in accordance with embodiments of the disclosure can also be folded and can accordingly function as a table clock, content viewer, or auxiliary display when in a bent condition. It should be obvious to those of ordinary skill in the art having the benefit of this disclosure that the electronic device 800 can function as other devices as a function of its physical geometry, including as a gaming device, a media player, or other device.

As with the electronic device (100) of FIGS. 1-8, in one or more embodiments the electronic device 800 of FIG. 8 has a device housing 804 that is divided into three sections, namely, a first section 801, a second section 802, and a third section 803. In this illustrative embodiment, the first section 801 comprises a first display 805. The second section 802, which is bendably coupled to the first section 801, is devoid of any display. The third section 803, which is bendably coupled to the second section 802, comprises a second display (facing into the page from the third section 803 in FIG. 8).

As before, the first display 805 and the second display 815 are situated on opposite sides of the electronic device 800. Accordingly, in this illustrative embodiment the first display 805 and the second display 815 are oppositely facing.

In the illustrative embodiment of FIG. 8, the first display 805 and/or the second display 815 are rigid displays. However, as noted above with reference to FIG. 6, in other embodiments the first display 805 and/or the second display are configured as flexible displays.

In this illustrative embodiment, the device housing 804 includes one or more linkage members situated at the first deformable portion 809 and the second deformable portion 810 that allow the first section 801 and the third section 803 to be hingedly coupled to the second section 802. Said differently, the linkage members (described below with reference to FIG. 9) allow portions of the device housing 804 to pivot about the first deformable portion 809 and the second deformable portion 810 so that the electronic device 800 becomes bendable and/or foldable.

While the device housing 804 can be manufactured from segments of a rigid material that each bend around a linkage member, such as is the case in FIG. 8, as noted above the device housing 804 can take other configurations as well. Illustrating by example, the device housing 804 can be manufactured from a bendable material that both supports the first display 805 and the second display 815 and allows for deformation of the device housing 804 at the first deformable portion 809 and the second deformable portion 810 as well.

Features can be incorporated into the device housing 804. Examples of such features include an optional image capture device 811 or an optional speaker port 813, which are shown situated in the second section 802 of the electronic device 800 that is devoid of displays in this embodiment but could be placed at other locations as well. A user interface component 812, which may be a button or touch sensitive surface, can also be disposed along second section 802. As noted, any of these features are shown being disposed on the front side of the electronic device 800 in this embodiment, but could be located elsewhere, such as on the front side in other embodiments.

In this illustrative embodiment, the device housing 804 includes three rigid segments defining the three sections 801,802,803, with each of those sections 801,802,803 being linked together by a plurality of linkage members situated in the first deformable portion 809 and the second deformable portion 810. Said differently, in this illustrative embodiment the device housing 804 includes one or more linkage members, which are described in more detail below with reference to FIG. 9, that allow the electronic device 800 to be deformed by bending or folding at the first deformable portion 809 and the second deformable portion 810. In other embodiments, the first deformable portion 809 and second deformable section comprise a combination of rigid segments connected by hinges, pivots, or flexible materials. Still other constructs will be obvious to those of ordinary skill in the art having the benefit of this disclosure.

As with the embodiment of FIG. 1, in the illustrative embodiment of FIG. 8 each section of the first section 801, the second section 802, and the third section 803 are the same size. Said differently, in one or more embodiments the first section 801, the second section 802, and the third section 803 have major surfaces that occupy the same area. In one or more embodiments, this equal area allows an aspect ratio for the first display 805 and the second display 815 to be the same.

In one or more embodiments, the aspect ratio of the first display 805 and the second display 815 is 21:9. In other embodiments, the aspect ratio of the first display 805 and the second display 815 is 8:9. These aspect ratios are illustrative only, as others will be readily obvious to those of ordinary skill in the art having the benefit of this disclosure.

The fact that the first section 801 is hingedly coupled to the second section 802, with the third section 803 also being hingedly coupled to the second section 802, allows the electronic device 800 of FIG. 8 to be configured as a many different devices. Advantageously, this allows the electronic device 800 to function as the equivalent to multiple devices depending upon the amount of deformation of the deformable housing 804.

For example, the electronic device 800 is shown in an unbent configuration in FIG. 8. However, when folded as was described above in FIG. 3, the electronic device 800 can function as a smartphone. By contrast, when folded as was described above in FIG. 4, the electronic device 800 can function as a tablet computer. Where folded as was described above in FIG. 5, two people situated on opposite sides of the electronic device 800 can each view a corresponding display.

Moreover, when folded as was described above with reference to FIG. 4, the electronic device 800 can then be partially folded between the first display 805 and the second display 815 to resemble a tent. That tent can be stood on a surface when the displays are facing outward, as was shown in FIG. 7. That tent can also be placed on a surface when the displays are facing inward in a stand configuration.

A block diagram schematic 814 of the electronic device 800 is also shown in FIG. 1. It should be noted that the components of the block diagram schematic 814 could be used equally in the electronic device (100) of FIG. 1. In one or more embodiments, the components of the block diagram schematic 814 are situated in the second section 802, which is devoid of displays.

The block diagram schematic 814 can be configured as a printed circuit board assembly disposed within the second section 802 of the device housing 804. Various components can be electrically coupled together by conductors, or a bus disposed along one or more printed circuit boards. Flexible circuit substrates can then span the first deformable portion 809 and the second deformable portion 810 to operate the first display 805 and second display 815, respectively.

In one or more embodiments, the electronic device 800 includes one or more processors 806. In one embodiment, the one or more processors 806 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 800. Each of the application processor and the auxiliary processor(s) can be configured to process and execute executable software code to perform the various functions of the electronic device 800. A storage device, such as memory 807, can optionally store the executable software code used by the one or more processors 806 during operation.

In this illustrative embodiment, the electronic device 800 also includes a communication circuit 816 that can be configured for wired or wireless communication with one or more other devices or networks. The networks can include a wide area network, a local area network, and/or personal area network. The communication circuit 816 may also utilize wireless technology for communication, such as, but are not limited to, peer-to-peer or ad hoc communications such as HomeRF, Bluetooth and IEEE 802.11, and other forms of wireless communication such as infrared technology. The communication circuit 816 can include wireless communication circuitry, one of a receiver, a transmitter, or transceiver, and one or more antennas 817.

In one embodiment, the one or more processors 806 can be responsible for performing the primary functions of the electronic device 800. For example, in one embodiment the one or more processors 806 comprise one or more circuits operable with one or more user interface devices, which can include the first display 805 and the second display 815, to present, images, video, or other presentation information to a user.

In one or more embodiments, the one or more processors 806 are configured to detect a geometric configuration of the electronic device 800, examples of which include the “alignment on the short edge” configuration (300), the “alignment on the long edge” configuration (400), the “back to back” configuration (500), the “loop” configuration (600), the “tent” configuration (700), a “stand” configuration (which is the “tent” configuration (700) of FIG. 7 with the electronic device (100) turned on its side with the first display (105) and the second display (205) facing inward), or other configurations.

In one or more embodiments, the one or more processors 806 are then configured to segment content 818 for presentation into a first content portion 819 and a second content portion 820. In one or more embodiments, the one or more processors 806 then cause the first display 805 to present the first content portion 819 and the second display 815 to present the second content portion 820.

In other embodiments, such as when the geometric configuration is defined by the first section 801 abutting the second section 802 and the third section 803 abutting the second section with the first display 805 and the second display 815 facing in opposite directions, i.e., the “back-to-back” configuration (500) of FIG. 5 above, embodiments of the disclosure contemplate that when a single user is using the electronic device 800 they will not be able to see one of the displays. Accordingly, in one or more embodiments the one or more processors 806 will cause a display not facing a person to cease the presentation of content 818.

In one or more embodiments, whether to present content or cease presenting content will be triggered by detecting a person's gaze upon a display. If, for example, the one or more sensors 821 detect a first person viewing the first display 805 when the electronic device 800 is in the “back to back” configuration (500) and a second person viewing the second display 815 when the electronic device is in the “back to back” configuration (500), the one or more processors 806 can segment content 818 for presentation into a first content portion 819 and a second content portion 820 and cause the first display 805 to present the first content portion 819 and the second display 815 to present the second content portion 820. By contrast, when the one or more sensors 821 detect only a single person gazing a single display, the one or more processors 806 can omit the segmentation and simply present the content 818 on the display to which the user's gaze is directed.

The executable software code used by the one or more processors 806 can be configured as one or more modules 822 that are operable with the one or more processors 806. Such modules 822 can store instructions, control algorithms, logic steps, and so forth.

In one embodiment, the one or more processors 806 are responsible for running the operating system environment of the electronic device 800. The operating system environment can include a kernel and one or more drivers, and an application service layer, and an application layer. The operating system environment can be configured as executable code operating on one or more processors or control circuits of the electronic device 800. The application layer can be responsible for executing application service modules. The application service modules may support one or more applications or “apps.” The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the electronic device 800 optionally includes one or more flex sensors 823, operable with the one or more processors 806, to detect a bending operation that causes the first deformation portion 809 and/or second deformation portion 810 to deform, thereby transforming the electronic device 800 into a deformed geometry. The inclusion of flex sensors 823 is optional, and in some embodiment flex sensors 823 will not be included. Where flex sensors 823 are not included and device operation is a function of the amount of deformation of the first deformation portion 809 and/or second deformation portion 810, the user can alert the one or more processors 806 to the fact that the one or more bends are present through the user interface or by other techniques.

In one embodiment, the flex sensors 823 comprise passive resistive devices manufactured from a material with an impedance that changes when the material is bent, deformed, or flexed. By detecting changes in the impedance as a function of resistance, the one or more processors 806 can use the one or more flex sensors 823 to detect bending of the first deformation portion 809 and/or second deformation portion 810. In one or more embodiments, each flex sensor 823 comprises a bi-directional flex sensor that can detect flexing or bending in two directions. In one embodiment, the one or more flex sensors 823 have an impedance that increases in an amount that is proportional with the amount it is deformed or bent.

In one embodiment, the one or more processors 806 may generate commands or execute control operations based on information received from the various sensors, including the one or more flex sensors 823, the user interface, or the other sensors 821. The one or more processors 806 may also generate commands or execute control operations based upon information received from a combination of the one or more flex sensors 823, the user interface, or the other sensors 821. Alternatively, the one or more processors 806 can generate commands or execute control operations based upon information received from the one or more flex sensors 823 or the user interface alone. Moreover, the one or more processors 806 may process the received information alone or in combination with other data, such as the information stored in the memory 807.

The one or more other sensors 821 may include a microphone, an earpiece speaker, a second loudspeaker (disposed beneath speaker port 813), and a user interface component 812, such as a button or touch-sensitive surface. The one or more other sensors 821 may include one or more of an accelerometer, gyroscope, image capture device, and/or display touch sensors to determine whether the electronic device 800 is being held on the base side or flip side in a portrait mode.

The one or more other sensors 821 may also include key selection sensors, proximity sensors, a touch pad sensor, a touch screen sensor, a capacitive touch sensor, and one or more switches. Touch sensors may be used to indicate whether any of the user actuation targets present on the first display 805 and/or second display 815 are being actuated. Alternatively, touch sensors disposed in the electronic device 800 can be used to determine whether the electronic device 800 is being touched at side edges or major faces of the device housing 804. The touch sensors can include surface and/or housing capacitive sensors in one embodiment. The other sensors 821 can also include audio sensors and video sensors (such as a camera).

The other sensors 821 can also include motion detectors, such as one or more accelerometers or gyroscopes. For example, an accelerometer may be embedded in the electronic circuitry of the electronic device 800 to show vertical orientation, constant tilt and/or whether the electronic device 800 is stationary. A gyroscope can be used in a similar fashion.

Other components 824 operable with the one or more processors 806 can include output components such as video outputs, audio outputs, and/or mechanical outputs. Examples of output components include audio outputs such as speaker port 813, earpiece speaker, or other alarms and/or buzzers and/or a mechanical output component such as vibrating or motion-based mechanisms. Still other components will be obvious to those of ordinary skill in the art having the benefit of this disclosure.

In one or more embodiments, the electronic device 800 comprises a plurality of energy storage devices operable to power the electronic device 800 as well. Each energy storage device can take a variety of forms, examples of which include lithium-ion and lithium polymer electrochemical cells.

Charging circuitry can be included to selectively individual, subsets, or all of the plurality of energy storage devices when depleted. In one or more embodiments, the charging circuitry comprises a charging node that is coupled to each energy storage device of the plurality of energy storage devices.

It is to be understood that FIG. 8 is provided for illustrative purposes only and for illustrating components of one electronic device 800 in accordance with embodiments of the disclosure and is not intended to be a complete schematic diagram of the various components required for an electronic device. Therefore, other electronic devices in accordance with embodiments of the disclosure may include various other components not shown in FIG. 8 or may include a combination of two or more components or a division of a particular component into two or more separate components, and still be within the scope of the present disclosure.

Turning now to FIG. 9, illustrated therein are sectional views of the linkage members 900 that allow deformation of the electronic device (800). As shown, the linkage members 900 define a multi-link hinging mechanism for the electronic device (800). While three linkage members 901,902,903 are shown for simplicity, in most embodiments an electronic device (800) will include more linkage members. However, in some embodiments electronic devices configured in accordance with embodiments of the disclosure can include fewer linkage as well.

In one embodiment, each of the linkage members 901,902,903 is stepped with the rigid purlins 904,905,906 to receive and protect an optional cover layer 915, which (where included) is flexible. In one or more embodiments, a locking bar can be integrated with the linkage members 901,902,903 to further improve rigidity and constrain motion.

As used herein, a “purlin” is defined as a beam along a width of the optional cover layer 915 rests. This is similar to the architectural purlin, which is a horizontal beam along the length of a roof, resting on a main rafter and supporting the common rafters or boards. The purlins 904,905,906 disposed between the optional cover layer 915 and the linkage members 901,902,903 provide mechanical support.

In this illustrative embodiment, linkage members 901,902,903 are all similarly configured with links 907,908 separating each linkage member 901,902,903. Each linkage member 901,902,903 comprises a pivot 909,910,911. The pivot 909,910,911 can be configured with mechanical features that provide drive functions, resistance functions, stage stop functions, and other functions that alter the way that the electronic device (800) deforms. For example, the pivot 909,910,911 can house cam and follower assemblies, geared assemblies, spring assemblies, and other assemblies that assist the electronic device (800) in deforming, oppose the way that the electronic device (800) deforms, or otherwise increase or decrease the amount of force required to cause the electronic device (800) to deform.

In one or more embodiments, the linkage members 901,902,903 provide one or more different mechanical functions for the electronic device (100). Illustrating by example, the linkage members 901,902,903 can provide mechanical support for the cover layer 915 when the device housing (104) is planar in the open position shown above in FIG. 1. Moreover, when the electronic device (100) is in the folded position, the purlins 904,905,906 move together to provide full support for the underside major surface of the cover layer 915, which is disposed adjacent to the linkage members 901,902,903.

In one or more embodiments, the linkage members 901,902,903 can be configured to provide one or more optional mechanical functions as well. For example, in one embodiment, the linkage members 901,902,903 provide a stop stage that operates to retain the electronic device (800) in a particular geometric configuration, examples of which include the “tent” configuration (700) or “stand” configuration. If the amount of force required to deform the electronic device (800) is, for example, five Newtons ordinarily, the inclusion of a stop stage in the linkage members 901,902,903 may require a greater amount of force, such as eleven Newtons, to bend the electronic device (800) from the open position.

Turning now to FIG. 10, illustrated therein is another deformable electronic device 1000 configured in accordance with one or more embodiments of the disclosure. The deformable electronic device 1000 of FIG. 10 comprises a plurality of sections, namely, a first section 1001 and a third section 1003, comprising a corresponding display 1005 (the display attached to the third section 1003 is facing into the page).

In the illustrative embodiment of FIG. 10, the deformable electronic device 1000 also includes at least one section devoid of any display. This “at least one section” of FIG. 10 is the second section 1002, to which no display is attached. As before, in the embodiment of FIG. 10, the first section 1001 and the third section 1003 are bendable relative to the second section 1002. Additionally, as was the case with the electronic device (100) of FIG. 1 above, the first display 1005 and the second display are oppositely facing.

Once again, in this illustrative embodiment each section of the first section 1001, the second section 1002, and the third section 1003 are the same size in that the first section 1001, the second section 1002, and the third section 1003 have the same length 1007 and width 1008. In one or more embodiments, the length 1007 and width 1008 define an aspect ratio for the first display 105 and the second display. Since the length 1007 and width 1008 of each of the first section 1001, the second section 1002, and the third section 1003 is the same in this illustrative embodiment, the aspect ratio of the first display 1005 and the second display are the same.

In one or more embodiments, the aspect ratio of the first display 1005 and the second display is 21:9. In other embodiments, the aspect ratio of the first display 1005 and the second display is 8:9. These aspect ratios are illustrative only, as others will be readily obvious to those of ordinary skill in the art having the benefit of this disclosure. The aspect ratio of the first display 1005 and the second display in FIG. 10 is 8:9.

The fact that the first section 1001 is hingedly coupled to the second section 1002, with the third section 1003 also being hingedly coupled to the second section 1002, allows the electronic device 1000 of FIG. 10 to be configured as a many different devices. For example, when folded as was described above in FIG. 3, the electronic device 1000 can function as a smartphone. By contrast, when folded as was described above in FIG. 4, the electronic device 1000 can function as a tablet computer. Where folded as was described above in FIG. 5, two people situated on opposite sides of the electronic device 1000 can each view a corresponding display. Where the first display 1005 and the second display are flexible, and when the electronic device 1000 is folded as was described above with reference to FIG. 6, the electronic device 100 can be configured in a loop so as to be worn on a wrist.

Moreover, when folded as was described above with reference to FIG. 4, and then partially folded between the first display 1005 and the second display, the electronic device 1000 can be configured as a tent or stand and can accordingly function as a table clock, content viewer, or auxiliary display when in a bent condition. It should be obvious to those of ordinary skill in the art having the benefit of this disclosure that the electronic device 1000 can function as other devices as a function of its physical geometry, including as a gaming device, a media player, or other device.

To this point, the number of sections of each electronic device carrying displays has been two sections, while the at least one section that is devoid of a display comprises only one section. This was the case with the electronic device (100) of FIG. 1 where the first section (101) carried a first display (105), the third section (103) carried a second display (205), and the second section (102) was devoid of any display. It was also true with the electronic device (800) of FIG. 8, where the first section (801) carried a first display (805), the third section (803) carried a second display (815), and the second section (802) was devoid of any display. It is true of FIG. 10 as well.

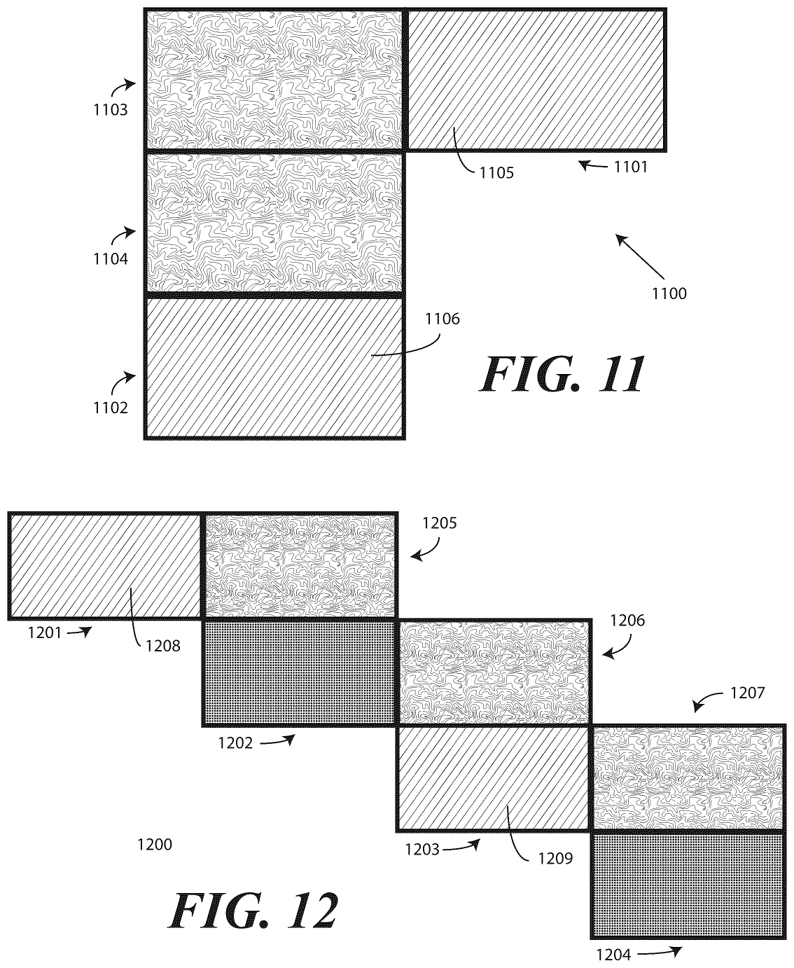

However, embodiments of the disclosure are not so limited. Illustrating by example, turning now to FIG. 11, illustrated therein is another deformable electronic device 1100 comprising a plurality of sections carrying a display and at least one section that is devoid of a display. In the illustrative embodiment of FIG. 11, there are two sections, namely a first section 1101 and a second section 1102, that carry displays. In this example, the first section 1101 carries a first display 1105 while the second section 1102 carries a second display 1106. In FIG. 11, there are also two sections that are devoid of displays, namely, a third section 1103 and a fourth section 1104. In this embodiment, each section is hingedly coupled to each other. Thus, not only can the first section 1101 and the second section 1102 bend relative to the third section 1103 and fourth section 1104, respectively, so too can the third section 1103 relative to the fourth section 1104. Thus, arrangements such as the “aligned along the long side” configuration and the “back-to-back” configuration can be easily achieved using the teachings described above.

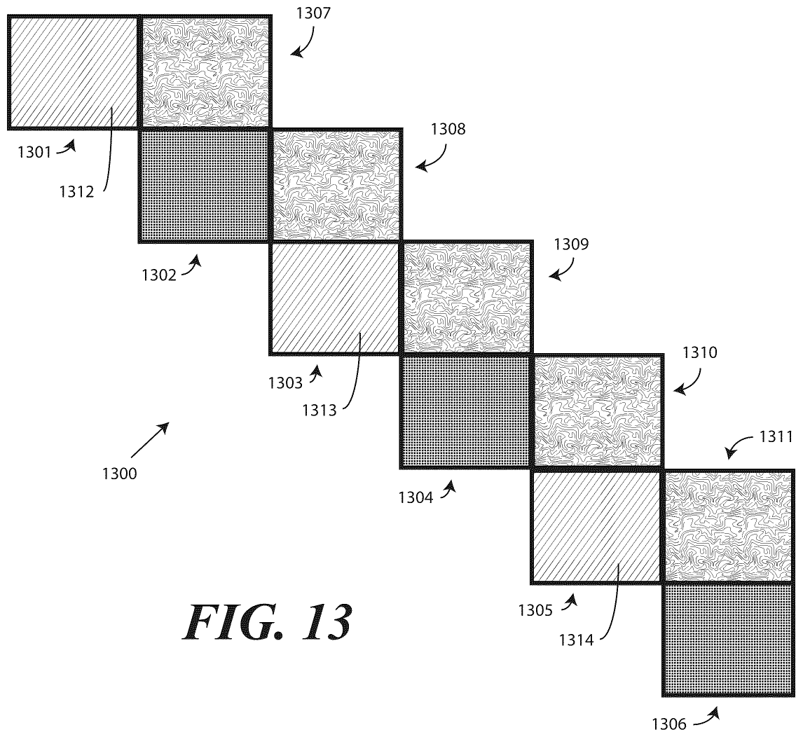

Embodiments of the disclosure also contemplate that the number of sections carrying displays and those devoid of displays can be expanded geometrically as well. Illustrating by example, turning to FIG. 12, illustrated therein is one explanatory deformable electronic device 1200 having four sections 1201,1202, 1203,1204 carrying displays 1208, 1209 (the displays carried by sections 1202,1204 are facing into the page) and three sections 1205,1206, 1207 that are devoid of displays. Turning to FIG. 13, illustrated therein is a deformable electronic device 1300 having six sections 1301, 1302, 1303, 1304, 1305,1306 carrying displays 1312, 1313, 1314 (the displays carried by sections 1302,1304,1306 are facing into the page) and five sections 1307,1308,1309,1310,1311 that are devoid of displays.

By comparing FIGS. 1, 8, 10, 12, and 13, it can be seen that as the number of sections carrying displays and sections devoid of displays increases, it is frequently the case that the plurality of sections carrying displays is one section greater than the number of sections devoid of displays. This is certainly true of FIGS. 1, 8, 10, 12, and 13. Moreover, in each embodiment, the corresponding deformable electronic device defines a stair-stepped perimeter.

A more general way of thinking about the relationship between the number of sections carrying displays and the number of sections devoid of displays for most embodiments is represented by the following equation, in which the number of sections that are devoid of displays is equal to:

$$2 * ( X - 1 ) , \qquad [ EQ . 1 ]$$

where:

X is a quantity of sections carrying displays.

Thus, if there are four sections carrying displays, there can be six sections devoid of displays. If there are six sections carrying displays, there can be ten non-display sections, and so forth. Other configurations will be obvious to those of ordinary skill in the art having the benefit of this disclosure.

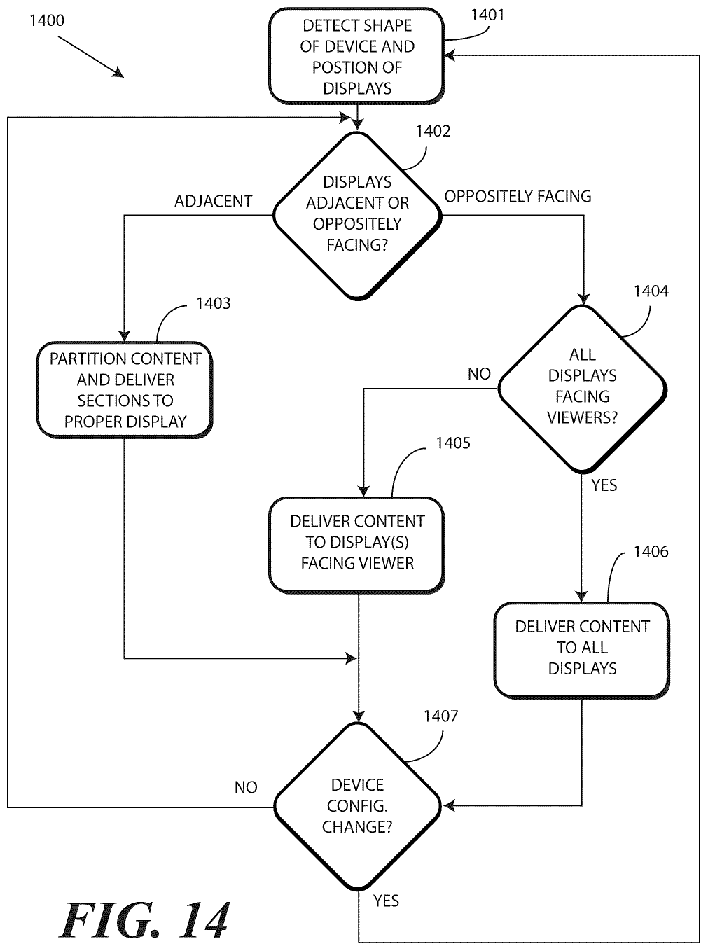

Turning now to FIG. 14, illustrated is one explanatory method 1400 suitable for use in a deformable electronic device configured in accordance with one or more embodiments of the disclosure. The method 1400 is directed to how content can be presented upon multiple displays depending upon the geometric configuration of the deformable electronic device. While a deformable electronic device having two sections carrying displays and one section devoid of any displays will be used as an illustrative example, it will be obvious to those of ordinary skill in the art having the benefit of this disclosure that the method can be expanded for more sections carrying displays just as FIGS. 12-13 expanded the number of displays from that shown in FIGS. 1, 8, and 10.

Beginning at step 1401, the method 1400 detects, optionally using one or more sensors of the deformable electronic device, deformation of the deformable electronic device. In one or more embodiments, the deformable electronic device comprises a first section carrying a first display, a second section bendably coupled to the first section and devoid of any display, a third section bendably coupled to the second section and carrying a second display. Decision 1402 determines, again optionally using the one or more sensors, whether the deformation results in the first display and the second display being adjacent or oppositely facing.

When the first display and the second display are oppositely facing, decision 1404 determines whether all displays are facing viewers. Said differently, decision 1404 determines whether a person is gazing at each display. Where they are, step 1406 segments presentation content into a first content portion and a second content portion and causes, using one or more processors, the first display to present the first content portion and the second display to present the second content portion. In one or more embodiments, such as would be the case when the deformable electronic device is in a tent configuration, the first content portion and the second content portion may each comprise different content. This would allow a first user, for example, to watch a television show on one side of the deformable electronic device while another user plays a video game on the other.

Where decision 1404 determines that users are not looking at each display, as might be the case when the deformable electronic device is in the “back-to-back” configuration and is being held in the hand of a single user, step 1405 can comprise causing the display facing the person to present content while the display failing to receive any user gaze ceases the presentation of content.

When decision 1402 determines that the first display and the second display are adjacent, step 1403 can segment presentation content into a first content portion and a second content portion and causes, using one or more processors, the first display to present the first content portion and the second display to present the second content portion. In one or more embodiments when the first display and the second display are coplanar, the first content portion will be half of the content and the second content portion will be another half of the content, so that when these portions are presented side by side on the adjacent displays, it appears as a singular content offering to the viewer.

Decision 1407 then determines whether the geometric configuration of the deformable electronic device changes. Where it does, the method 1400 can repeat.

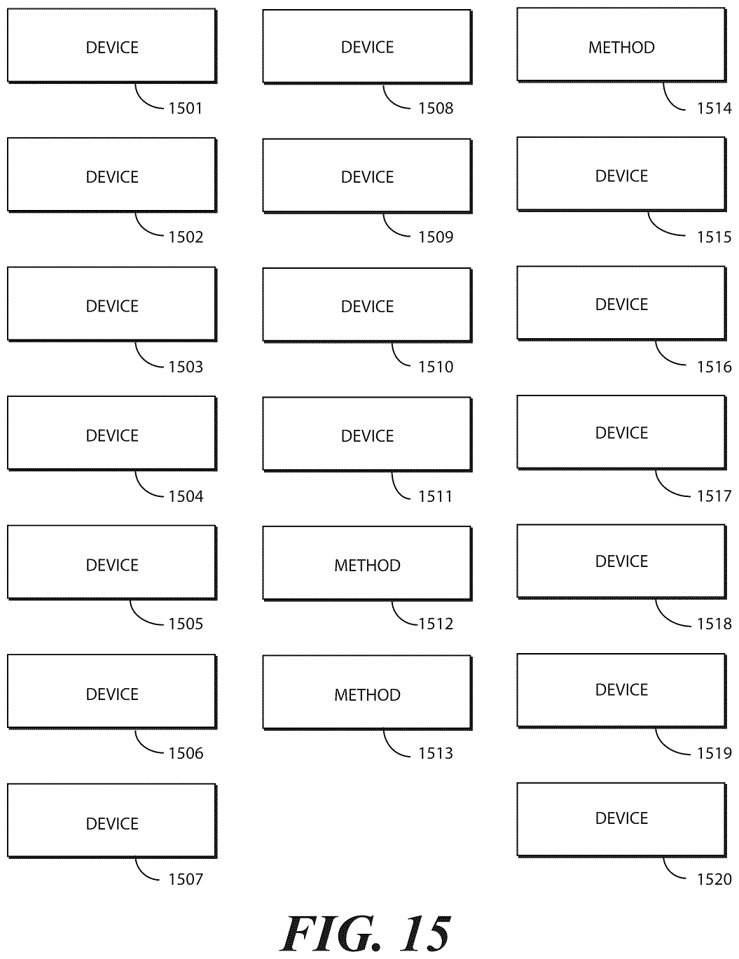

Turning now to FIG. 15, illustrated therein are various embodiments of the disclosure. The embodiments of FIG. 15 are shown as labeled boxes in FIG. 15 due to the fact that the individual components of these embodiments have been illustrated in detail in FIGS. 1-14, which precede FIG. 15. Accordingly, since these items have previously been illustrated and described, their repeated illustration is no longer essential for a proper understanding of these embodiments. Thus, the embodiments are shown as labeled boxes.

At 1501, a deformable electronic device comprises a first section comprising a first display, a second section bendably coupled to the first section and devoid of any display, and a third section bendably coupled to the second section and comprising a second display. At 1501, the first display and the second display are oppositely facing.

At 1502, the first section, the second section, and the third section are equal in size. At 1503, an aspect of the first display and the second display of 1502 is one of an 8:9 aspect ratio or a 21:9 aspect ratio.

At 1505, the first section and the third section of 1501 are hingedly coupled to second section. At 1505, the deformable electronic device of 1501 further comprises a deformable housing spanning the first section, the second section, and the third section. At 1505, the deformable housing defines a first deformable portion between the first section and the second section and a second deformable portion between the second section and the third section.

At 1506, the first display and the second display of 1505 are flexible. At 1507, the deformable housing of 1506 is also deformable along a major axis of each of the first section, the second section, and the third section. At 1507, when the first section is bent relative to the second section such that the first section and second section abut, and the third section is bent relative to the second section such that the second section and third section abut, such that the first display and second display are adjacent and define an exterior surface of the deformable electronic device, the deformable electronic device can be deformed into a loop.

At 1508, the deformable electronic device of 1501 further comprises one or more processors operable to present content on the first display and the second display. At 1509, the one or more processors of 1508 are situated in the second section.

At 1510, the one or more processors of 1508 are configured to detect a geometric configuration of the deformable electronic device where the first display and the second display are adjacent, segment content for presentation into a first content portion and a second content portion and cause the first display to present the first content portion and the second display to present the second content portion.

At 1511, the one or more processors of 1508 are configured to detect a geometric configuration of the deformable electronic device where the first section abuts the second section, and the third section abuts the second section with the first display and the second display facing opposite directions and cease presentation of content on one of the first display or the second display.

At 1512, a method comprises detecting, using one or more sensors, deformation of a deformable electronic device comprising a first section comprising a first display, a second section bendably coupled to the first section and devoid of any display, and a third section bendably coupled to the second section and comprising a second display. At 1512, the method comprises determining, using the one or more sensors, whether the deformation results in the first display and the second display being adjacent or oppositely facing.

At 1512, when the first display and the second display are adjacent, the method comprises segmenting presentation content into a first content portion and a second content portion and causing, by one or more processors, the first display to present the first content portion and the second display to present the second content portion. At 1512, when the first display and the second display are oppositely facing, the method comprises one of causing, by the one or more processors, the first display to present the presentation content and the second display to cease presentation of any content or causing, by the one or more processors, the first display to present the presentation content and the second display to present other presentation content.

At 1513, the method of 1512 further comprises, when the first display and the second display are partially oppositely facing, causing, by the one or more processors, the first display to present the presentation content and the second display to present the other presentation content. At 1514, the method of 1513 further comprises determining, with the one or more sensors, whether user gaze falls on one or both of the first display or the second display. At 1514, when the first display and the second display are oppositely facing or partially oppositely facing the causing the first display to present the presentation content on the first display and the other presentation content on the second display occurs only when the user gaze falls on both the first display and the second display.

At 1515, a deformable electronic device comprises a plurality of sections each comprising a corresponding display and at least one section devoid of any display. At 1515, at least two sections of the plurality of sections are bendable relative to the at least one section. At 1515, displays of the at least two sections are oppositely facing.

At 1516, the plurality of sections of 1515 comprises two sections and the at least one section comprises two other sections. At 1517, the plurality of sections of 1515 comprises four sections and the at least one section comprises three sections.

At 1518, the at least one section of 1515 comprises a number of sections according with a formula equal to:

$$2 * ( X - 1 ) , \qquad [ EQ . 1 ]$$

where: X is a quantity of sections in the plurality of sections.

At 1519, the plurality of sections of 15 is one section greater than the at least one section. At 1520, the deformable electronic device of 1515 defines a stair-stepped perimeter.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

1. A deformable electronic device, comprising:
a first section comprising a first display;
a second section bendably coupled to the first section and devoid of any display; and
a third section bendably coupled to the second section and comprising a second display;
wherein the first display and the second display are oppositely facing.

2. The deformable electronic device of claim 1, wherein the first section, the second section, and the third section are equal in size.

3. The deformable electronic device of claim 2, wherein an aspect ratio of the first display and the second display is one of an 8:9 aspect ratio or a 21:9 aspect ratio.

4. The deformable electronic device of claim 1, wherein the first section and the third section are hingedly coupled to second section.

5. The deformable electronic device of claim 1, further comprising a deformable housing spanning the first section, the second section, and the third section, wherein the deformable housing defines a first deformable portion between the first section and the second section and a second deformable portion between the second section and the third section.

6. The deformable electronic device of claim 5, wherein the first display and the second display are flexible.

7. The deformable electronic device of claim 6, wherein deformable housing is also deformable along a major axis of each of the first section, the second section, and the third section such that when the first section is bent relative to the second section such that the first section and second section abut and the third section is bent relative to the second section such that the second section and third section abut such that the first display and second display are adjacent and define an exterior surface of the deformable electronic device the deformable electronic device can be deformed into a loop.

8. The deformable electronic device of claim 1, further comprising one or more processors operable to present content on the first display and the second display.

9. The deformable electronic device of claim 8, wherein the one or more processors are situated in the second section.

10. The deformable electronic device of claim 8, wherein the one or more processors are configured to:
detect a geometric configuration of the deformable electronic device where the first display and the second display are adjacent;
segment content for presentation into a first content portion and a second content portion; and
cause the first display to present the first content portion and the second display to present the second content portion.

11. The deformable electronic device of claim 8, wherein the one or more processors are configured to:
detect a geometric configuration of the deformable electronic device where the first section abuts the second section, and the third section abuts the second section with the first display and the second display facing opposite directions; and
cease presentation of content on one of the first display or the second display.

12. A method, comprising:
detecting, using one or more sensors, deformation of a deformable electronic device comprising a first section comprising a first display, a second section bendably coupled to the first section and devoid of any display, and a third section bendably coupled to the second section and comprising a second display;
determining, using the one or more sensors, whether the deformation results in the first display and the second display being adjacent or oppositely facing; and
when the first display and the second display are adjacent, segmenting presentation content into a first content portion and a second content portion and causing, by one or more processors, the first display to present the first content portion and the second display to present the second content portion; and
when the first display and the second display are oppositely facing, one of:
causing, by the one or more processors, the first display to present the presentation content and the second display to cease presentation of any content; or
causing, by the one or more processors, the first display to present the presentation content and the second display to present other presentation content.

13. The method of claim 12, further comprising, when the first display and the second display are partially oppositely facing, causing, by the one or more processors, the first display to present the presentation content and the second display to present the other presentation content.

14. The method of claim 13, further comprising determining, with the one or more sensors, whether user gaze falls on one or both of the first display or the second display, wherein when the first display and the second display are oppositely facing or partially oppositely facing the causing the first display to present the presentation content on the first display and the other presentation content on the second display occurs only when the user gaze falls on both the first display and the second display.

15. A deformable electronic device, comprising:
a plurality of sections each comprising a corresponding display; and
at least one section devoid of any display;
wherein at least two sections of the plurality of sections are bendable relative to the at least one section and displays of the at least two sections are oppositely facing.

16. The deformable electronic device of claim 15, wherein the plurality of sections comprises two sections and the at least one section comprises two other sections.

17. The deformable electronic device of claim 15, wherein the plurality of sections comprises four sections and the at least one section comprises three sections.

18. The deformable electronic device of claim 15, wherein the at least one section comprises a number of sections according with a formula equal to:
2*(X−1), where:
X is a quantity of sections in the plurality of sections.

19. The deformable electronic device of claim 15, wherein the plurality of sections is one section greater than the at least one section.

20. The deformable electronic device of claim 15, wherein the deformable electronic device defines a stair-stepped perimeter.
